(19) United States
(12) Patent Application Publication
(10) Pub. No.: US 2008/0024864 A1
(43) Pub. Date: Jan. 31, 2008

(54) Signaling assembly

(75) Inventor: Thomas P. Alberti, Port Washington, WI (US)

Correspondence Address: WELLS ST. JOHN P.S., 601 W. FIRST AVENUE, SUITE 1300, SPOKANE, WA, 99201, US

(73) Assignee: K.W. Muth Company, Inc.

(21) Appl. No.: 11/495,132

(22) Filed: Jul. 28, 2006

(51) Int. Cl. G02B 5/12

(52) U.S. Cl. 359/515; 359/839

(57) ABSTRACT

A signaling assembly is described and which includes a semitransparent mirror formed of a glass substrate formed of neodymium oxide doped glass and which absorbs, at least in part, a predetermined band of yellow light, and which further defines a region through which visible light may pass; and an emitter of visible light is positioned adjacent to the semitransparent mirror and which, when energized, emits visible light which passes through the region of the semitransparent mirror which passes visible light to form a visibly discernible signal.

### TECHNICAL FIELD

The present invention relates to a signaling assembly for use on overland vehicles and the like, and which, on the one hand, may operate as a combined warning lamp and rearview mirror, and which provides other benefits to the operator of the overland vehicle.

### BACKGROUND OF THE INVENTION

The beneficial effects of employing auxiliary signaling assemblies have been disclosed in various U.S. patents including U.S. Pat. Nos. 5,014,167; 5,207,492; 5,355,284; 5,361,190; 5,481,409; 5,528,422; 6,749,325; and 6,918,685; all of which are incorporated by reference herein. As a general matter, some of the previous prior art signaling assemblies have successfully employed a dichroic mirror which is operable to reflect a broad band of electromagnetic radiation, within the visible light portion of the spectrum, while simultaneously permitting electromagnetic radiation having wavelengths which reside within a predetermined spectral band to pass therethrough. In this fashion, the dichroic mirror remains an excellent visual light reflector, that is, achieving luminous reflectance which is acceptable for automotive and other industrial applications, while simultaneously achieving an average light transmittance in the predetermined band which allows luminous emitters to be employed which typically produce an amount of light which is useful as a visual signal, and which further produces no significant deleterious effects on the resulting signaling assembly such as might be occasioned by the production of adverse heat energy which could damage other devices located within an associated mirror housing.

In U.S. Pat. No. 6,005,724, a mirror coating, a mirror utilizing same, and mirror assembly were disclosed and wherein the mirror coating has a primary region where it reflects visibly discernable electromagnetic radiation, and a secondary region, or multiple secondary regions, which pass a portion of the visibly discernable electromagnetic radiation while simultaneously reflecting a given percentage of the visibly discernable electromagnetic radiation. In this United States patent, the mirror coating provided with same was ablated, in a given pattern, in order to facilitate the passage of electromagnetic radiation therethrough. As seen from FIG. 9, the ablation of the mirror coating as provided with same produces a discernable region or blemish “B”, in the mirror coating. However, in view of the spacing and arrangements of the ablations, the usefulness of the resulting signaling assembly is maintained and the average reflectance of the entire surface of the mirror associated with same remains acceptable for automotive and other applications.

In U.S. Pat. No. 6,076,948, the teachings of which are incorporated by reference herein, an electromagnetic radiation emitting or receiving assembly is disclosed, and which includes a supporting substrate having opposite first and second surfaces, and further having an area formed therein which allows electromagnetic radiation to pass therethrough. A reflector is positioned adjacent to the second surface of the substrate and oriented in a given position relative to the area formed in the substrate, and an electromagnetic radiation emitter is mounted on the second surface of the substrate and which emits a source of electromagnetic radiation which is reflected by the reflector through the area formed in the supporting substrate which passes electromagnetic radiation. In this regard, the reflector, as shown in the drawings, is disposed in an eccentric substantially covering relation relative to the electromagnetic radiation emitter in order to provide a resulting assembly which has highly desirable performance characteristics and a reduced thickness dimension. As seen in FIG. 8 of that patent, and in certain forms of the invention, the mirror coating provided with a semitransparent mirror has been ablated in a predetermined pattern to facilitate the passage of electromagnetic radiation therethrough. Further, as contemplated by the same invention, a dichroic mirror may be substituted in place of the ablated neutrally chromatic mirror in certain applications. However, as pointed out in that particular patent, and other references, the use of dichroic mirrors, while showing promise, have not been widely embraced in assemblies of this type because of the difficulties and costs associated with the fabrication of dichroic mirrors of this type and which typically includes the application of multilayer mirror coatings which would render the resulting semitransparent mirror with the desired dichroic characteristics. As noted, above, these dichroic mirrors have been difficult to manufacture due, in part, to the nature of the prior art dichroic mirrors. More specifically, the prior art dichroic mirrors have been designed to merely allow a narrow band of electromagnetic radiation to pass therethrough while reflecting broad bands of electromagnetic radiation outside of the band of electromagnetic radiation which is passed. Such prior art dichroic mirrors are shown in U.S. Pat. Nos. 5,619,374; and 5,528,422, the teachings of which are incorporated by reference herein. As a general matter, these dichroic mirrors were formed of a transparent, neutrally chromatic substrate, and a dichroic mirror coating which was applied thereto to impart the resulting semitransparent mirror with the optical characteristics noted, above.

In U.S. Pat. No. 5,844,721 to Karpen, a motor vehicle rearview mirror was disclosed and which includes glass containing neodymium oxide, a rare earth compound. In this patent, the inventor discloses that neodymium oxide filters out or absorbs naturally occurring yellow light produced by a hot incandescent filament thereby producing a color-corrected light. In this regard, the neodymium oxide mirrors eliminate excessive yellow light and thereby reduces eye strain currently resulting from light emitted by conventional headlights of vehicles in a rearview mirror during hours of darkness. Additionally, the neodymium oxide glass will filter out the yellow light which originates from the rising or setting sun, and which may be, on occasion, reflected in the rearview mirror. The inventor in this patent discloses a mirror formed of a glass substrate having neodymium oxide in the amount from about 5% to about 20% by weight as a dopant throughout the entire thickness of the glass. This same doped glass further absorbs up to 95% to 98% of the reflected spectral energy of light of the wavelengths between 565 and 598 nanometers. This range of wavelengths is typically characterized as yellow light.

Additionally, U.S. Pat. No. 6,416,867 and U.S. Pat. No. 6,450,652 to Karpen further disclose the use of a neodymium oxide containing glass substrate and the advantageous benefits attributed to the absorption of yellow light by means of the neodymium oxide doping which is provided in this type of glass.

The references noted above are all incorporated by reference herein. While all the references noted above have operated with varying degrees of success, shortcomings have been attendant to the use of such teachings. For example, and while the earlier reference to Karpen appears to disclose the effective use of a neodymium oxide mirror in order to reduce glare, some prior art signaling assemblies have used electromagnetic radiation emitters which emit light within the band of radiation, that is, yellow light which is substantially absorbed by a neodymium oxide mirror. Still further, the costs associated with the fabrication of a dichroic glass substrate which might achieve similar benefits have proven to be substantial. Moreover, and as signaling assemblies have increased in complexity, the number of light transmitting regions formed in the semitransparent mirror have increased in number. Therefore, the number of blemished areas provided in such semitransparent mirrors have detracted from the aesthetic acceptability of these same assemblies in certain applications, and on many vehicle platforms.

A signaling assembly which addresses many of the shortcomings attendant with the prior art practices and teachings provided heretofore is the subject matter of the present application.

### SUMMARY OF THE INVENTION

A first aspect of the present invention relates to a signaling assembly which includes a dichroic semitransparent mirror which absorbs a narrow band of visible light while simultaneously reflecting a broad band of visible light; and an emitter of visible light positioned adjacent to the dichroic semitransparent mirror and which emits light which is passed by the dichroic semitransparent mirror.

Another aspect of the present invention relates to a signaling assembly which includes a semitransparent mirror formed of a glass substrate having a mirror coating, and wherein the glass substrate absorbs, at least in part, a predetermined band of yellow light, and which further defines a region through which visible light may pass, and wherein the mirror coating defines a primary region which reflects visible light and a secondary region adjacent thereto and which is ablated, in part, to remove the mirror coating and which further passes visible light, while simultaneously reflecting visible light, and wherein the average reflectance of the primary and secondary regions is greater than about 50%, and wherein at viewing distances of greater than about 4 feet under normal ambient lighting conditions, the primary and secondary regions are not normally discernable; and an emitter of visible light is positioned adjacent to the semitransparent mirror and which, when energized, emits visible light which passes through the secondary region of the mirror coating and forms a visibly discernible signal.

Another aspect of the present invention relates to a signaling assembly which includes a semitransparent mirror formed of a neodymium oxide doped glass substrate having a forward facing, and an opposite rearward facing surface, and a reflective layer positioned on the rearward facing surface thereof, and wherein the semitransparent mirror defines a primary region which reflects less than about 20% of a source of visible light having a first portion with wavelengths of about 565 to about 598 nanometers, and a bandwidth of less than about 35 nanometers, and greater than about 50% of a second portion of the visible light having wavelengths which lie within a range of about 400 to about 700 nanometers, and further having a bandwidth of greater than about twice the bandwidth of the first portion of the source of visible light, and which strikes the forward facing surface thereof, and wherein the semitransparent mirror further defines a secondary region, which is adjacent to the primary region, and which passes less than about 20% of the visible light having a wavelength of about 565 to about 598 nanometers, and greater than about 70% of the second portion of the visible light; and an emitter of visible light positioned in light transmitting relation relative to the rearward facing surface of the neodymium oxide doped glass substrate, and adjacent to the secondary region thereof, and wherein the emitter, when energized, emits the second portion of the visible light which is passed by the secondary region, and which forms a visibly discernible signal when viewed at a distance from the forward facing surface.

Still yet another aspect of the present invention relates to a signaling assembly which includes an enclosure defining an aperture; a neodymium oxide doped semitransparent mirror borne by the enclosure and positioned in substantially occluding relation relative to the aperture, and wherein the neodymium doped semitransparent mirror reflects and passes a broad band of visible light while simultaneously absorbing, at least in part, a predetermined band of yellow light; and an emitter of visible light borne by the enclosure and emitting visible light within the broad band of visible light which is passed by the neodymium doped semitransparent mirror.

These and other aspects of the present invention become more readily apparent hereinafter.

### BRIEF DESCRIPTION OF THE DRAWINGS

Preferred embodiments of the invention are described below with reference to the following accompanying drawings.

FIG. 1 is a perspective, side-elevation view of one form of the invention in a deenergized state.

FIG. 2 is a perspective, side-elevation view of one form of the invention in an energized state.

FIG. 3 is a perspective, side-elevation view of one form of the invention in a deenergized state.

FIG. 4 is a perspective, side-elevation view of one form of the invention in an energized state.

FIG. 5 is a fragmentary, greatly enlarged, plan view of a mirror coating ablation pattern which finds usefulness in the present invention.

FIG. 6 is an exploded, plan view of a reflector, and electromagnetic radiation emitter of the present invention.

FIG. 7 is a fragmentary, transverse, vertical sectional view of one form of the invention taken from a position along 7-7 of FIG. 2.

FIG. 7A is a fragmentary, transverse, vertical sectional view of an alternative form of the invention taken from a position along 7-7 of FIG. 2.

FIG. 8 is a greatly simplified, perspective, exploded view of several possible forms of the present invention.

FIG. 9 is a side elevation view of a prior art semitransparent mirror and the visibly discernable ablated pattern or blemish “B” which can be seen therein.

### DETAILED DESCRIPTION OF THE PREFERRED EMBODIMENTS

This disclosure of the invention is submitted in furtherance of the constitutional purposes of the U.S. patent Laws “to promote the progress of science and useful arts” (Article 1, Section 8).

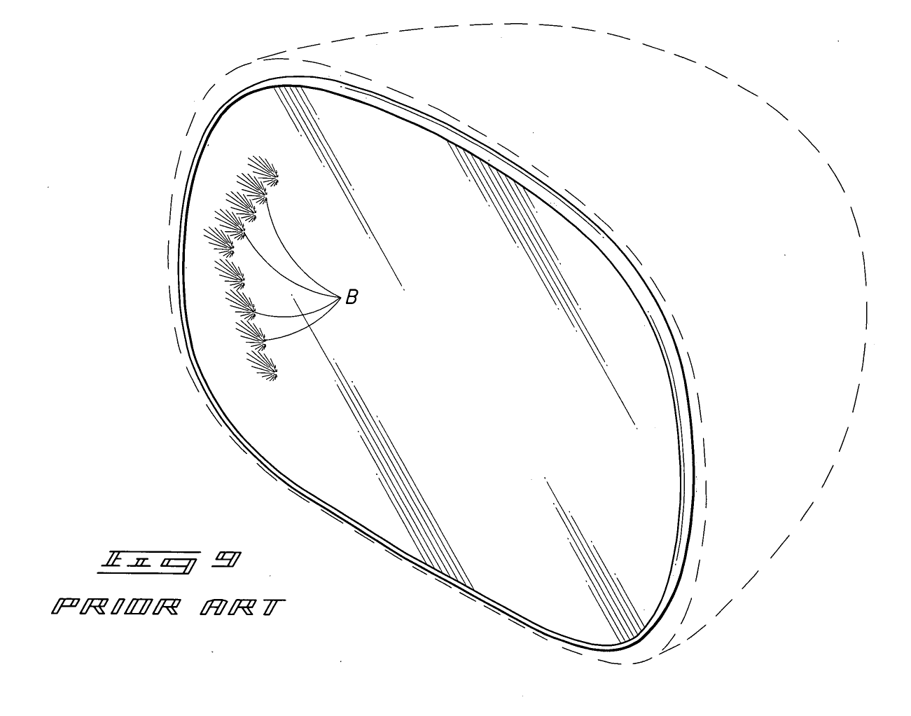

Referring more particularly to the drawings, the signaling assembly of the present invention is generally indicated by the numeral 10 in FIG. 8. For illustrative convenience, the assembly 10 of the present invention is described hereinafter as it would be configured if it were installed on an automobile (not shown) of conventional design. As discussed in the aforementioned prior art patents which are all incorporated by reference herein, the assembly 10 of the present invention may be mounted on the automobile in place of the rearview mirror which is located in the passenger compartment and/or in place of the side view mirrors which are mounted on the exterior surface of the vehicle. The assembly 10 of the present invention will be discussed in greater detail in the paragraphs which follow.

The signaling assembly 10 of the present invention, in one form, operates in combination with a dichroic semitransparent mirror to provide a combined rearview mirror and visual signaling device, and wherein a portion of the visual signal provided by same is capable of being seen from locations horizontally, laterally, outwardly, and rearwardly of the vehicle and further cannot normally be seen under most circumstances by the operator of the same vehicle.

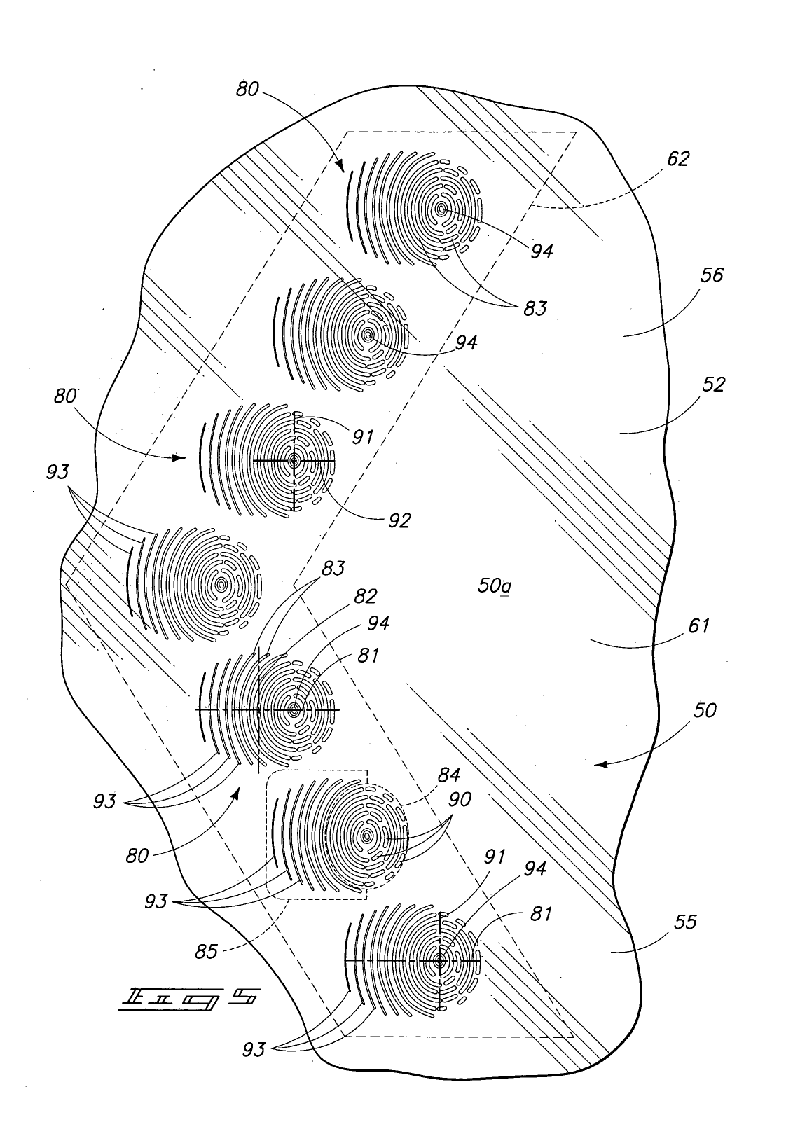

In addition to the foregoing, and in another form of the invention, the present invention provides a signaling assembly which includes a dichroic semitransparent mirror having a neutrally chromatic mirror coating which has a primary region which reflects visible light, and a secondary region adjacent thereto, and which is ablated, in part, to completely remove the neutrally chromatic mirror coating. In this regard, the ablated portion passes visible light, while simultaneously reflecting visible light. Still further, the average reflectance of the primary and secondary regions of the resulting semitransparent mirror, in this form of the invention, is greater than about 50%, and at viewing distances of greater than about 4 feet under normal ambient lighting conditions, the primary and secondary regions are not normally discernable. This form of the invention, as will be seen in FIGS. 3, 4 and 5, readily obviates the problems associated with producing signaling assemblies which have discernable blemishes as seen in several of the prior art patents, and which is illustrated most clearly by a study of FIG. 8 where the blemished regions “B” are readily identifiable.

As best illustrated by reference to FIG. 8, the assembly 10 of the present invention is mounted in the housing which is generally indicated by the numeral 11. The housing 11 is mounted at a predetermined location on the exterior portion of an overland vehicle (not shown), which are employed with same. The housing 11 includes a substantially continuous sidewall 13 which defines an aperture 14 of given dimensions. Further, the continuous sidewall 13 defines a cavity 15 which encloses the assembly 10.

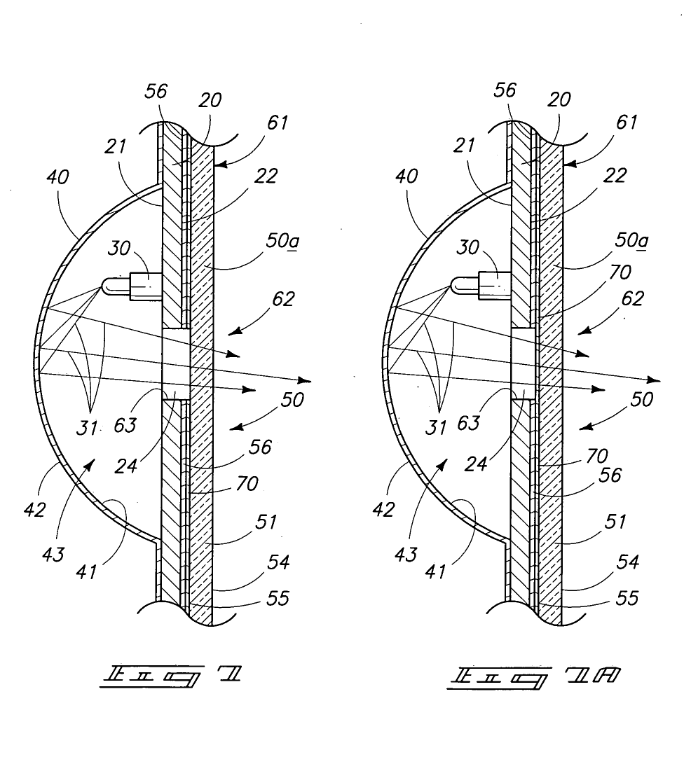

Referring now to FIG. 6, the assembly 10 includes a supporting substrate 20 which is typically fabricated, at least in part, from a dielectric material. The supporting substrate 20 is substantially planar, although curved and more angulated shapes are conceivably possible depending upon the end use of the apparatus 10. The supporting substrate 20 is substantially opaque, although transparent or semitransparent dielectric substrates could also be employed. In one form of the invention, the substrate 20 has a first surface 21, and an opposite second surface 22. Further, the supporting substrate is defined by a peripheral edge 23. Still further, the supporting substrate 20 has a plurality of areas or regions 24 formed therein which allows electromagnetic radiation to pass substantially unimpeded therethrough. In one form of the invention, as illustrated, these areas or regions 24 are depicted as apertures having given cross-sectional dimensions. The areas or apertures 24 are formed in the supporting substrate in a given pattern such that in the several forms of the invention, as shown, a recognizable symbol may be formed thereby. This symbol could be arrow shaped, as seen in the drawings, such that it could be employed as a directional signaling lamp on an automobile, or further it could be formed into any desired alpha-numeric symbol or other shape which might be used to indicate the current operational status of the overland vehicle by providing warnings to the operator regarding various operational conditions of the vehicle. As seen in FIG. 6, a plurality of electrically conductive pathways 25 are formed on the first surface 21. These conductive pathways are connected to a suitable source of electricity (not shown). The individual electrically conductive pathways 25 terminate at a given location 26 which is typically adjacent relative to each of the respective areas or regions which pass electromagnetic radiation such as the apertures 24.

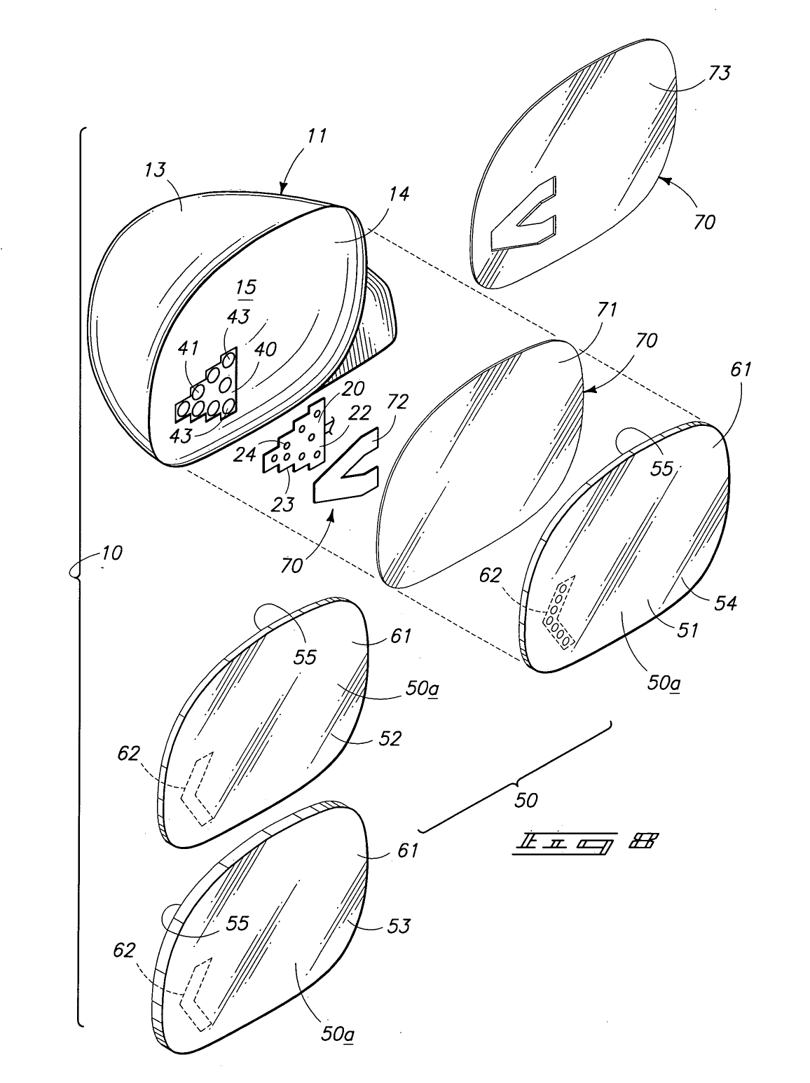

As seen in FIGS. 6 and 7, for example, an electromagnetic radiation emitter 30 is mounted on the first surface of the substrate 21, and emits a source of electromagnetic radiation or visible light 31. The respective emitters, which are herein illustrated as light emitting diodes are individually electrically coupled at the terminal ends 26 of each of the respective electrically conductive pathways 25, and to a source of electricity (not shown). Therefore, the emitters 30 are mounted adjacent to the apertures or areas 24 which allow or facilitate the passage of electromagnetic radiation, or visible light to pass therethrough. In the arrangement as seen in the drawings, and as discussed in several of the earlier U.S. patents, the respective emitters 30 comprise a plurality of light emitting diodes which may be energized as a group, or individually, depending upon the end use application. In the present arrangement, the emitters may emit light having wavelengths which lie in the range of 400-700 nanometers. The band of visible light which may be emitted may be greater than about 150 nanometers, and may, in some forms of the invention, include the band of yellow light which lies within the range of about 565 to about 598 nanometers. Yet further, a control circuit including an ambient light sensor may be employed in a fashion to increase or decrease the luminous output of the respective light emitting diodes or emitters 30 such that a resulting illuminated image may be visually discerned notwithstanding the intensity of the background ambient radiation which may be present. As seen in FIG. 6, the plurality of emitters 30 may comprise one to about ten, or more light emitting diodes. The light emitting diodes are operable to emit a sufficient number of candelas of light so as to form a visibly discernable signal at an effective distance from the overland vehicle when employed as a signaling assembly on the overland vehicle. In one form of the invention as will be discussed hereinafter, the respective emitters 30 emit visible light 31 having wavelengths which may lie, at least in part, within the range of about 565 to 598 nanometers. In another form of the invention, the emitter 30 emits light having wavelengths which are outside of this range (565 to 598 nanometers). Visible light having wavelengths of about 565 to about 598 nanometers is typically characterized as yellow light.

A reflector 40 is positioned adjacent to or mounted on the first surface 21 of the substrate 20. The reflector 40 is oriented in a given position relative to the area or region 24 which is formed in the substrate 20 and through which electromagnetic radiation or visible light 31 can pass. The reflector 40, as seen in the drawings, is positioned in covering, eccentric or offset reflecting relation relative to the respective emitters 30. In this orientation, the reflector can reflect the visible light 31 such that it may pass through the regions 24 formed in the substrate 20 and be passed by the dichroic semitransparent mirror as will be described below. In the arrangement as seen, the reflector 40 has a polished and highly reflective inside facing surface 41 which is operable to reflect a preponderance of the visible light 31 which strikes the inside facing surface 41. This highly reflective inside facing surface is typically neutrally chromatic. Although it is conceivable, in some forms of the invention, that a dichroic layer of material may be applied thereto. Such a dichroic layer may include neodymium oxide which, as will be discussed hereinafter, is effective for absorbing yellow light. This dichroic coating may be useful for the purposes as more fully described in U.S. Pat. No. 6,958,758, the teachings of which are incorporated by reference herein. The reflector 40 further has an opposite outside facing surface 42. The reflector 40 may be formed into a unitary sheet such that a plurality of reflector pockets 43 may be individually associated with or aligned relative to the respective regions or apertures 24 which are formed in the supporting substrate 20. This is seen in FIGS. 7 and 7A, for example. As should be understood, and while the drawings illustrate a single emitter 30, associated with a single reflector 40, it should be appreciated that in some forms of the invention, the individual reflectors may be positioned in covering relation relative to two or more emitters 30. Still further, and while the inside facing surface 41 of the reflector 40 is shown as having a substantially uniform curvature, it will be understood that the inside facing surface 41 may be formed into various angulated reflecting facets (not shown), and which are useful for reflecting electromagnetic radiation or visible light 31 in various orientations outwardly relative to the region 24, and which is formed in the substrate 20, and which passes this same radiation. Therefore, in some forms of the invention, emitted electromagnetic radiation or visible light 31 may pass in the same direction, or in diversely angulated orientations relative to the substrate 20 in order to achieve various benefits which will become more apparent hereinafter.

As noted above, the individual reflectors 40 are seen in the drawings as being positioned in substantially covering, eccentric or offset reflecting relation relative to the respective emitters 30. In this orientation, the reflector 40 as seen in FIGS. 7 and 7A, for example, is operable to reflect electromagnetic radiation or visible light 31 in a direction whereby it is typically angularly displaced by at least about 20 degrees, or more, relative to the first surface 21. As noted above, and depending upon the shape of the inside facing surface 41, of the reflector 40, the direction with which the visible light 31 may pass through the aperture 24 may be varied depending upon the design of the signaling assembly 10 and the needs of the overland vehicle. In this regard, and in some arrangements, where more than one emitter 30 is associated with a single reflector 40, the inside facing surface 41 may be arranged so as to reflect light of a first emitter, through the aperture 24 such that a visible signal is formed which can be seen at a location horizontally, laterally, outwardly relative to the intended direction of an overland vehicle. Still further, and when another light emitting diode is energized, the light 31 provided or emitted by that second light emitting diode 30 may pass through the same aperture 24 and may be directed horizontally, laterally, inwardly relative to the overland vehicle such that the emitted light may be seen, for example, by the operator of the overland vehicle. Such may be the case in those instances where the individual emitters 30 are being utilized as a warning lamp for the benefit of the operator of the overland vehicle. In addition to the foregoing, the inside facing surfaces 41 of the respective reflectors 40 may be shaped in a number of ways in order to achieve a degree of collimation of the emitted electromagnetic radiation or visible light 31.

Referring now to FIG. 8, the present invention generally includes a semitransparent mirror 50 which is fabricated, in part, from a dichroic, transparent, neodymium doped glass substrate 50A. The semitransparent mirror 50 as seen in FIG. 8 includes first, second and third forms which are generally indicated by the numerals 51, 52 and 53, respectively. Contrary to the prior art teachings, as earlier discussed, and wherein prior art dichroic semitransparent mirrors were formed of a transparent neutrally chromatic substrate which had a dichroic mirror coating applied thereto, the present invention employs a transparent dichroic glass substrate, and a neutrally chromatic mirror coating as will be discussed in greater detail below, to form the dichroic semitransparent mirror. As will be discussed in greater detail below, this arrangement provides many advantages over the previous dichroic mirror designs utilized heretofore.

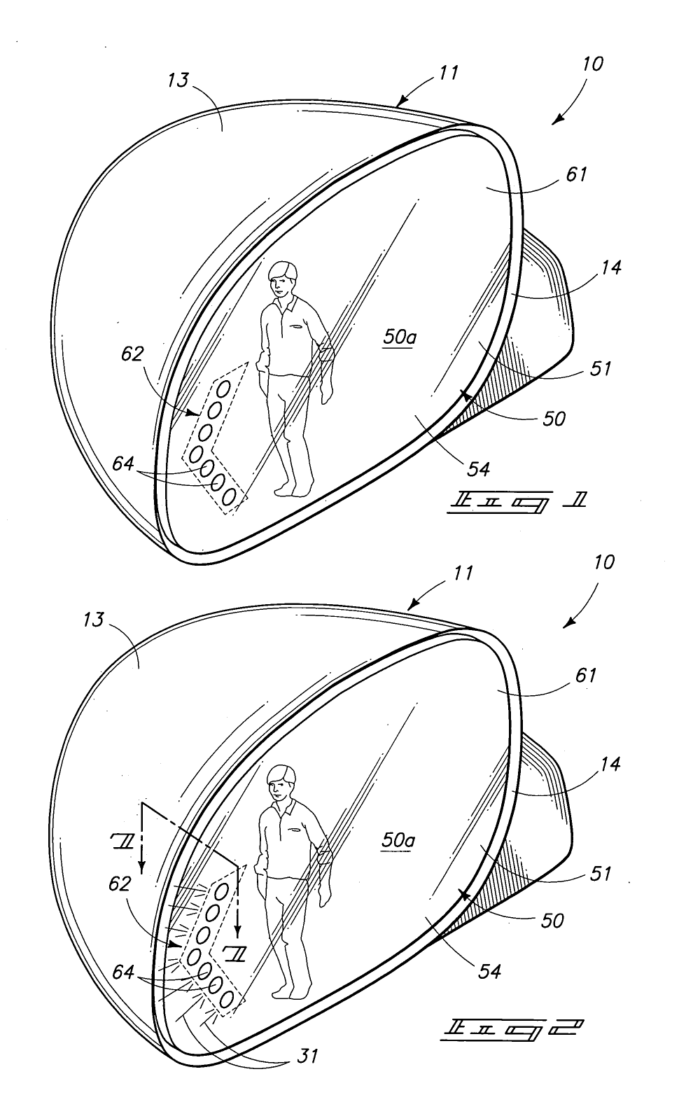

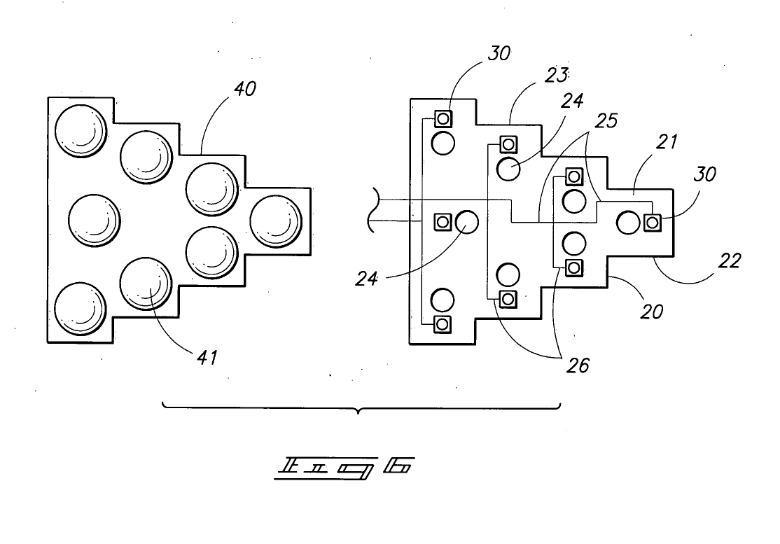

As seen in FIGS. 1, 7 and 8, the first form of the invention 51 comprises a dichroic semitransparent mirror formed from a dichroic glass substrate 50A which has an effective concentration of neodymium oxide and wherein a portion of a neutrally chromatic reflective coating formed on the semitransparent mirror 51 is ablated to form visibly discernable apertures or regions through which electromagnetic radiation or visible light may pass. These will be discussed in greater detail below. Still further, the second form of the semitransparent mirror employed in the present invention relates to a semitransparent mirror 52 having a reflective mirror coating applied thereto, and wherein a plurality of ablations, as seen in FIG. 5, are formed therein in such a manner that when viewing the semitransparent mirror at distances of greater than about 4 feet under normal ambient lighting conditions, the ablations cannot normally be seen (FIGS. 3 and 4). This aspect of the invention will be discussed in greater detail below. Still further, a third form 53 of the semitransparent mirror 50 includes the use of a dichroic neodymium oxide doped glass substrate which is incorporated within the structure of an electrochromic mirror of traditional design. In the third form of the invention, the dichroic neodymium oxide doped glass substrate may have ablations similar to that seen in the first form of the invention 51, or the second form of the invention 52 (FIG. 5). As illustrated in FIGS. 7 and 7A, it will be seen that the dichroic semitransparent mirror 50 has a first outwardly facing surface 54, and a second inwardly facing surface 55 upon which a reflective mirror coating 56 is applied. As seen from the drawings, regardless of the dichroic mirror selected, the second surface 55 is juxtaposed or positioned in closely adjacent relation relative to the second surface 22 of the supporting substrate 20. The several forms of the invention will now be discussed in greater detail in the paragraphs which follow.

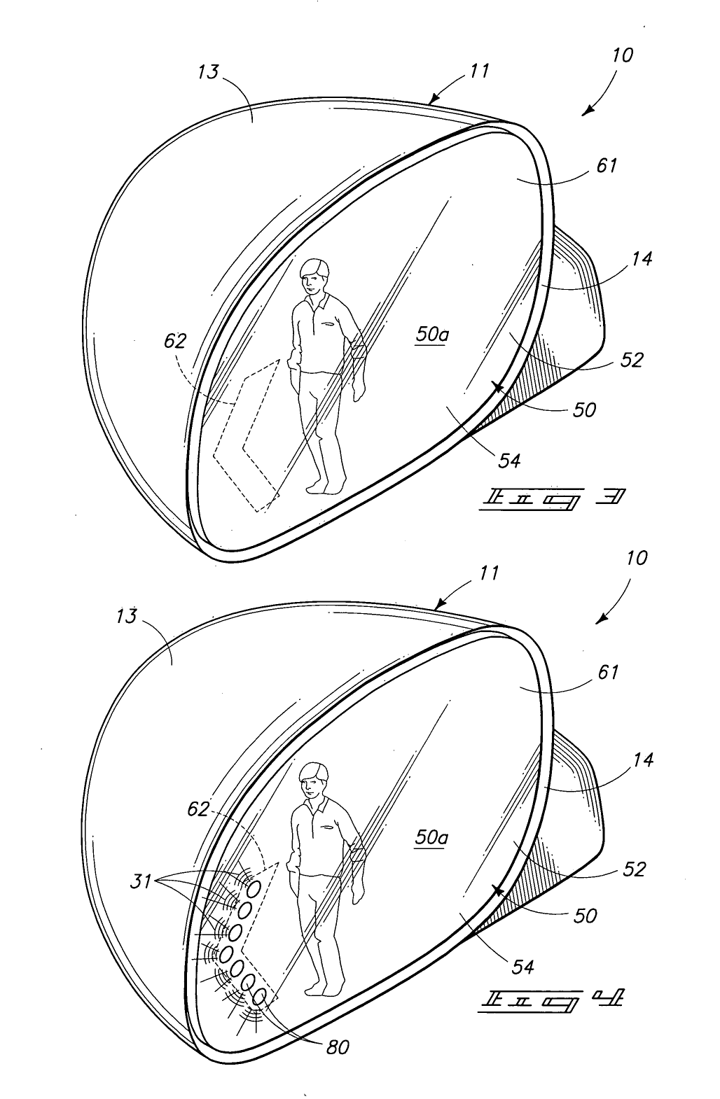

As earlier discussed, the dichroic semitransparent mirror 50 may include a first form as seen in FIGS. 1 and 2, and in FIG. 8, and wherein a dichroic neodymium oxide doped glass substrate 50A forming the semitransparent mirror has a neutrally chromatic reflective surface or mirror coating 56 comprising chromium or a similar material, which is borne by the second surface 55 thereof. Although, it is possible in some forms of the invention, that the reflective surfaces 56 could also be applied to the first surface 54. As seen in the drawings, the first form of the semitransparent mirror 51 is illustrated in FIGS. 1 and 7, and wherein the dichroic semitransparent mirror 50 is formed of a dichroic neodymium transparent glass substrate 50A having a neutrally chromatic mirror coating 56, applied thereto, and wherein the dichroic glass substrate 50A spectrally absorbs, at least in part, a predetermined narrow band of visible light, and which further defines a region through which visible light may pass. In this regard, the dichroic semitransparent mirror 50 defines a primary region 61 which reflects visible light; and a secondary region 62 which is adjacent thereto, and which is ablated, in part, to remove the mirror coating 56 and which further passes visible light while simultaneously reflecting visible light (FIGS. 7 and 7A). In this regard, the average reflectance of the primary and secondary regions is greater than about 50%. Still further, and in one form of the invention as seen in FIGS. 3, 4 and 5, the ablation pattern may be rendered or performed in such a manner that at viewing distances of greater than about 4 feet, under normal ambient lighting conditions, that the primary and secondary regions 61 and 62 are not normally discernible except when the invention 10 is energized (FIG. 4). Further discussion regarding the second form of the invention 52 will be provided hereinafter. With respect to the first form of the semitransparent mirror 51, and wherein a portion 63 of the neutrally chromatic reflective surface or mirror coating 56 has been removed to define the semitransparent secondary region 62, it will be understood that this removal of the portion 63 may be achieved by various means such as by laser ablation; chemical-mechanical polishing; and masking to name but a few. As seen in FIGS. 1 and 2, for example, the removal of the reflective coating 56 may be to such a degree, in some applications, whereby small discrete apertures or windows 64 are discernable, and which are formed in a predetermined pattern. As seen with respect to the first form of the semitransparent mirror 51, the removal of the reflective surface or neutrally chromatic mirror coating 56 results in a discrete blemish or window 64 which can be visually discerned at normal viewing distances. Heretofore, such blemished regions 64 have not typically aesthetically detracted from the overall stylish appearance of the resulting mirror assembly 10. However, as the number of emitters or other warning devices 30 have increased in the mirror, the removal of the mirror coating 56 has begun to detract from the stylish appearance of the resulting semitransparent mirror 50.

In one form of the invention 10, which utilizes the first form 51 of the dichroic semitransparent mirror 50, it will be seen, by a study of FIG. 2, that when the electromagnetic radiation emitter 30 is energized, it produces visible light 31 which is reflected by the reflector 40, and thereafter passes out through the secondary region 62 which is defined, at least in part, by a plurality of ablations or blemished regions 64, and then passes through the dichroic neodymium oxide glass substrate 50A which forms, at least in part, the dichroic semitransparent mirror 50 (FIG. 7). The visible light 31 passing through the dichroic neodymium oxide doped glass substrate 50A forms a discernable image as seen in FIGS. 2 and 4, and which can be typically seen laterally, outwardly relative to the overland vehicle. However, as earlier discussed, and depending upon the configuration and arrangement of the reflector 40, that same light 31, which is supplied by the electromagnetic radiation emitters 30, might be reflected laterally inwardly; downwardly; and in assorted other directions depending upon the design of the signaling assembly 10. Depending upon the concentration of the neodymium oxide in the dichroic neodymium oxide doped glass substrate 50A, as much as about 95% of wavelengths which comprise yellow light, that is, wavelengths which fall within a narrow band of visible light having the wavelengths of about 565 to about 598 nanometers may be absorbed. Providing that the emitted light 31 of the electromagnetic radiation emitter 30 does not fall within the band of electromagnetic radiation which is absorbed by the neodymium oxide doped glass substrate 50A, a readily discernable and acceptable visual signal will typically be provided. However, in those instances, where the signaling assembly 10 must produce a discernable yellow-colored image, then the arrangement, noted above, would not generally work with a great degree of success.

In the present invention, and as discussed more thoroughly in U.S. Pat. No. 5,844,721, the teachings of which are incorporated by reference herein, a dichroic neodymium oxide doped glass substrate 50A, such as used in the present invention, filters out yellow light to such a degree that it becomes an effective means by which the resulting signaling assembly 10, and more specifically the primary region 61 thereof, may be rendered effective to reduce the amount of glare that distracts or otherwise impairs the vision of the operator of an overland vehicle. The term “glare” as used herein is defined as the presence of one or more areas in the field of vision of an observer that are of sufficient brightness or intensity so as to cause a resulting unpleasant sensation; or a temporary blurring of vision; or a feeling of ocular fatigue. Glare may interfere with vision of the observer, sometimes seriously. Consequently, if the signaling assembly 10 employs a dichroic neodymium oxide doped glass substrate 50A which is incorporated into a semitransparent mirror 50, and having a concentration of neodymium oxide which is effective to absorb at least about 80% of yellow light which passes therethrough, then it should be readily obvious, that while this same substrate can be made into an effective dichroic semitransparent mirror for reducing glare, it will not be useful in passing yellow light that might be generated by the electromagnetic radiation emitters 30.

To address this difficulty, an alternative form of the invention is provided, and which is seen in FIGS. 7, 7A and 8. In this regard, a polarizing filter 70 may be provided and which is applied to the second surface 55 of the dichroic semitransparent mirror 50, and which is further positioned between the second surface 55 and the neutrally chromatic reflective mirror coating 56. The polarizing filter 70 which is provided is usually an effective absorber of yellow light. When a polarizing filter is employed, the concentration of the neodymium oxide as provided in the neodymium oxide glass substrate 50A can be significantly reduced so that, in combination, the dichroic neodymium oxide doped glass substrate 50A, and the polarizing filter 70 absorb a sufficient amount of yellow light so as to reduce the amount of glare while simultaneously allowing a sufficient amount of yellow light to pass therethrough in the event that at least one of the electromagnetic radiation emitters 30 supplies yellow light. As will be appreciated, if the emitter 30 produces yellow light, the polarizing film 70 would be removed in the vicinity of the secondary region 62 so as to allow increasing amounts of yellow light to pass through the neodymium oxide doped glass substrate (FIG. 7). This feature of the invention will be discussed below. It will be seen in FIGS. 7A and 8 that the polarizing filter 70 has a first form 71 where the polarizing filter covers substantially the entire second surface 55 of the semitransparent mirror 50. When used in this arrangement, the combination of the semitransparent mirror 50, and the polarizing filter 70 would substantially absorb approximately 80% or more of all bands of electromagnetic radiation which fall within the yellow portion of the spectrum, which is about 35 nanometers wide, and which lies in the range of about 565 to about 598 nanometers. An assembly such as this might be utilized in a signaling assembly 10 which utilizes emitters that provide red light, for example. In such an arrangement, red light 31 emitted by the emitters 30 would pass through both the polarizing filter 70 and the neodymium oxide doped glass substrate 50A in the secondary region 62 to form an acceptable discernable signal. It will be recognized that the arrangement of the polarizing filter covering substantially the entire second surface 55 results in a semitransparent mirror 50 which would be effective in reducing the amount of glare which could detract an operator or an overland vehicle, for example.

In another form of the invention 72, it will be seen that the polarizing filter 70 may not cover the entire surface, but rather may be shaped to be positioned in covering relation relative to merely the secondary region 62. In this form of the invention, the neodymium oxide doped glass substrate may have a reduced concentration of neodymium oxide such that increasing amounts of yellow light may pass therethrough, and be reflected thereby. This form of the invention may be useful when the emitter 30 produces light 31 which might be enhanced by the presence of the polarizing filter 70. For example, the polarizing filter 70 which is provided may be effective for absorbing other bands of light which lie predominately outside the range of about 568 to about 598 nanometers. In still another form of the invention 10 as seen in FIG. 8, and which is designated as numeral 73, the polarizing filter 70 may substantially cover the entire second surface 55 with the exception of the secondary region 62 (FIG. 7). When this arrangement as seen in FIG. 7 is employed, it would be effective for passing increasing amounts of yellow light through the secondary region 62. As discussed above, it will be understood, that when this form of the polarizing filters 70 is employed, the concentration of neodymium oxide is reduced in the glass substrate 50A. Consequently, the reduced absorption of yellow light by the dichroic neodymium oxide doped glass substrate 50A allows increasing amounts of yellow light to pass therethrough. In this arrangement, and while the primary region 61 of the mirror would be effective in absorbing, for example, 50% or more of yellow light striking its surface by the combined absorption of the glass substrate 50A and the associated polarizing film 70, the secondary region 62 would allow increasing amounts of yellow light to pass therethrough inasmuch as the polarizing filter would be absent from the secondary region 62. Consequently, an emitter producing yellow light could produce a sufficient amount of yellow light 31 which could pass through the secondary region 62 to form an acceptable visibly discernable signal that could be useful in a signaling assembly 10 of that specific design. However, the primary region 61 of semitransparent mirror 50 and which is covered by the polarizing filter 70 absorbs greater amounts of yellow light thereby reducing the glare which would be apparent to the operator of the overland vehicle.

Referring again to FIGS. 5 and 8, the second form 52 of the semitransparent mirror 50 includes a plurality of elliptically shaped light transmitting ablations 80 which are formed in a predetermined pattern, and which are operable to define, at least in part, the secondary region 62 which allows emitted electromagnetic radiation 31 provided by the emitters 30 to pass through the dichroic semitransparent mirror 50. As understood from these drawings, the elliptically shaped light transmitting ablations 80, which are formed in the neutrally chromatic mirror coating 56, are dimensioned so as to reflect, on average, greater than about 50% of visible light which strikes the secondary region 62. As seen in FIG. 5, each of the elliptically shaped light transmitting ablations 80 have a major axis 81, and a minor axis 82. Still further, each of the elliptically shaped light transmitting ablations 80 are defined by a plurality of ablated lines 83 which facilitate the transmission of the emitted visible light 31 provided by the emitters 30, in a direction which is principally along the major axis 81 thereof. The major axis 81 is typically substantially horizontally oriented, and parallel to the surface of the earth upon which the overland vehicle travels. In the arrangement as seen in FIG. 5, each of the elliptically shaped light transmitting ablations 80 have a first elliptically shaped zone 84; and a second zone 85 which is adjacent thereto. The first elliptically shaped zone 84 is formed of a plurality of discrete, curved, substantially concentrically oriented ablated lines which are generally indicated by the numeral 90. The first elliptically shaped zone 84 has a major axis 91, which is substantially normal relative to the major axis 81 of the elliptically shaped light transmitting ablation 80. Still further, the first elliptically shaped zone has a major axis 91 which is substantially normal relative to the major axis 81 of the elliptically shaped light transmitting ablation 80; and a minor axis 92 which is substantially coaxially aligned relative to the major axis 81. In the arrangement as seen in this form of the invention, the major axis 81 of the elliptically shaped light transmitting ablation 80 has a length dimension, and wherein the minor dimension of the first elliptically shaped zone 84 as measured along the minor axis 82, has a length dimension which is less than about 50% of the length dimension of the major axis 81 of the elliptically shaped light transmitting ablation 80. In the arrangement as seen in FIG. 5, the second zone 85 is defined by a plurality of spaced, continuous substantially arcuately shaped ablated lines 93. In this regard, the major axis 81 of the elliptically shaped light transmitting ablation 80 substantially bisects each of the arcuately shaped ablated lines 93. As seen in FIG. 5, the first elliptically shaped zone 84 has a geometric center designated by the numeral 94, and which is positioned along the major axis 81 of the elliptically shaped light transmitting ablation 80.

The ablated lines 90 and 93 forming the first and second zones 84 and 85 of the elliptically shaped light transmitting ablation 80 each have a diminishing width dimension when measured along the major axis 81 of the elliptically shaped light transmitting ablation 80, and in a direction extending from the geometric center 94 through the second zone 85. The ablated lines forming the first and second zones 84 and 85, respectively, have a width dimension of about ______ to about ______ mm., and the respective ablated lines of the first and second zones are positioned in spaced relation, one relative to the others, at a distance of about ______ to about ______ mm. In the arrangement as seen in FIG. 5, the major axis 81 of the elliptically shaped light transmitting ablation 80 has a length dimension of less than about 10 mm. and the minor axis 82 has a length dimension of less than about 8 mm. As seen in FIG. 5, the secondary region 62 of the mirror coating 56 has a plurality of light transmitting ablations 80 which are positioned in a spaced, predetermined geometric pattern, one relative to the others. In the arrangement as seen in FIGS. 3, 4 and 8, the semitransparent mirror 52 is mounted in a mirror housing 11 which is affixed to an overland vehicle (not shown), and the elliptically shaped light transmitting ablations 80 principally pass emitted light 31 provided by the emitters 30 in a direction which is horizontally, laterally, outwardly relative to the direction of movement of the overland vehicle.

In each of the forms of the invention, discussed above, a substantially neutrally chromatic mirror coating 56 is deposited on the second surface 55 of the dichroic neodymium oxide doped glass supporting substrate 50A, and wherein the neutrally chromatic mirror coating 56 defines a substantially continuous first or primary region 61, which reflects greater than about 70% of visible light, and a secondary region 62 which reflects greater than about 50% of visible light, and which further is ablated, at least in part, to completely remove the neutrally chromatic reflective mirror coating 56 so as to render the secondary region 62 operable to pass visible light 31. In the arrangement as seen in the drawings, a light emitting assembly, here illustrated as a plurality of electromagnetic radiation emitters 30 are positioned adjacent to the second surface 55 of the dichroic neodymium oxide doped glass supporting substrate 50A, and which, when energized, emits visible light 31 which passes through the secondary region 62 to form a visibly discernable signal which travels substantially horizontally, laterally, outwardly relative to the overland vehicle.

In the arrangement as seen in the drawings, a light transmitting ablation 80 is formed in the secondary region 62 of the reflective mirror coating 56, and wherein the elliptically shaped light transmitting ablation 80 is formed of a plurality of ablated lines 83 having dimensions which substantially prohibit the visible discernment of the elliptically shaped light transmitting ablation 80 at viewing distances of greater than about 4 feet under normal ambient lighting conditions when the light emitting assembly 30 is not energized (FIG. 3). In the arrangement as seen in the drawings, the elliptically shaped light transmitting ablation 80 is substantially elliptically shaped, and the plurality of ablations 83 are formed into a first elliptically shaped zone, and a second zone 84 and 85, respectively. Still further, each of the substantially elliptically shaped light transmitting ablations 80 have a major axis 81, having a length dimension; and a minor axis 82, which is normal thereto, and which has a length dimension which is less than the length dimension of the major axis. In the arrangement as seen in FIG. 5, the second zone 85 is formed of a plurality of spaced substantially arcuately shaped ablated lines 93, and wherein the second zone 85 has a length dimension when measured along the major axis 81 and which is at least about 50% of the length dimension of the major axis 81 of the substantially elliptically shaped light transmitting ablation 80. In the arrangement as seen in FIG. 5, the distance between the arcuately shaped ablated lines 93, forming the second zone 85, increase when measured along the major axis 81, and in a direction extending from the first zone 84, and through the second zone 85. In the arrangement as seen in FIG. 5 for example, the first zone 84 is substantially elliptically shaped, and is formed of a plurality of spaced substantially concentrically oriented ablated lines 90, and wherein the elliptically shaped first zone 84 has a major axis 91 which is positioned normal relative to the major axis 81 of the elliptically shaped light emitting ablation 80, and which further has a length dimension which is at least about 50% of the length dimension of the major axis 81 of the elliptically shaped light emitting ablation 80. In the arrangement as seen in the drawings, the major axis 81 of the elliptically shaped light emitting ablation 80 is substantially horizontal and further substantially bisects each of the plurality of arcuately shaped ablated line 93 forming the second zone 85. Still further, the concentrically oriented ablated lines 90 are discrete and discontinuous, and the arcuately shaped ablated lines 93 are substantially continuous.

### Operation

The operation of the described embodiment of the present invention is believed to be readily apparent and is briefly summarized at this point.

A signaling assembly 10 of the present invention includes a dichroic semitransparent mirror 50 which absorbs a narrow band of visible light while simultaneously reflecting a broad band of visible light, and an emitter of visible light 30 positioned adjacent to the dichroic semitransparent mirror and which emits visible light 31 which is passed by the dichroic semitransparent mirror. In addition to the foregoing, the signaling assembly of the present invention also includes a dichroic semitransparent mirror 50 formed of a glass substrate 50A, and having a neutrally chromatic reflective mirror coating 56 applied thereto. The semitransparent mirror 50 is operable to absorb, at least in part, a predetermined band of yellow light, and which further defines a region 62 through which visible light may pass. Still further, the signaling assembly 10 of the present invention includes an emitter of visible light 30 positioned adjacent to the semitransparent mirror 50 and which, when energized, emits visible light 31 which passes through the region 62 of the semitransparent mirror which passes visible light to form a visibly discernible signal. In the arrangement as seen in the drawings, the visible light 31 which is emitted by the emitter of visible light 30, in some forms of the invention, includes the band of visible light which is absorbed, at least in part, by the semitransparent mirror 50. In another form of the invention, the visible light 31 which is emitted by the emitter 30 of visible light does not include the band of visible light which is absorbed, at least in part, by the semitransparent mirror 50. In the present invention 10, the predetermined band of visible light which is absorbed has a yellow color, and the dichroic glass substrate 50A has an effective concentration of neodymium oxide which facilitates the absorption of yellow light. In one possible form of the invention, the effective concentration of the neodymium oxide renders the dichroic semitransparent mirror 50 substantially blue in appearance when viewed under artificial lighting conditions. In another concentration, the dichroic semitransparent mirror may appear red under the same lighting conditions. In addition to the foregoing, the present invention 10, in one form, may include a polarizing filter 70 which is borne by the rearward facing surface 55 of the dichroic semitransparent mirror 50, and which absorbs, at least in part, the predetermined band of yellow or other light 31, to further reduce the amount of the predetermined band of yellow or other light 31 which is reflected by the semitransparent mirror 50. In one form 71 of the invention as seen in the drawings, the polarizing film 70 covers substantially the entire surface area of the second or rearward facing surface area 55 of the semitransparent mirror 50. In another form 73 of the invention as seen, the polarizing film 70 covers only a portion of the surface area of the rearward facing surface 55 of the semitransparent mirror 50. In still yet another form 72, the polarizing film 70 covers the secondary region 62 of the semitransparent mirror and through which the visible light 31 may pass. In the arrangement as seen in the drawings and as discussed earlier, yellow light, when reflected, forms at least in part, glare which causes discomfort and diminishes an operator's view of regions which are located laterally outwardly and rearwardly of the overland vehicle, which is equipped with the signaling assembly 10 of the present invention. In the arrangement as earlier disclosed, the semitransparent mirror 50 reduces the amount of glare experienced by the operator when a source of light, having yellow light, is reflected by the semitransparent mirror 50, and into the eyes of the operator.

As seen in the drawings, the dichroic semitransparent mirror 50 may comprise, at least in part, a portion of an electrochromic mirror 53. In the present invention, the semitransparent mirror 50 has a forward and a rearward facing surface 54 and 55, respectively, and wherein the invention further includes a circuit substrate 20 which rests thereagainst the rearward facing surface 55 of the semitransparent mirror 50. In this arrangement, the emitter 30 of visible light is mounted on the circuit substrate 20, and the circuit substrate defines a region 24 through which visible light 31 may pass, and which is substantially aligned with the secondary region 62 of the semitransparent mirror which passes visible light. Still further, a reflector 40 is oriented in covering, substantially eccentric or offset reflecting relation relative to the emitter 30 of visible light, and which reflects the emitted visible light 31 through both the region 24 defined by the circuit substrate 20, and the secondary region 62 of the dichroic semitransparent mirror 50 which passes visible light 31 to form the visibly discernible signal. In the arrangement as seen in the drawings, the predetermined band of absorbed light comprises yellow light which has a bandwidth of less than about 35 nanometers, and wavelengths which lie predominately within the range of about 565 to about 598 nanometers. In the arrangement as seen in the drawings, the emitter 30 of visible light 31 emits visible light which is passed by semitransparent mirror 50, and which has a bandwidth of at least equal to the bandwidth of the yellow light, and further which has wavelengths which lie in the range of about 400 to about 770 nanometers. In one form of the invention, the dichroic semitransparent mirror 50 which is formed of a dichroic neodymium oxide doped glass substrate 50A optically absorbs greater than about 80% of yellow light. However, when a polarizing filter 70 is borne by the rearward facing surface 55, and further is rendered operable to absorb yellow light the semitransparent mirror, alone, absorbs less than about 60% of the yellow light and the polarizing film 70, alone, absorbs less than about 30% of the yellow light.

In the present invention, a signaling assembly 10 includes a semitransparent mirror 50 formed of a dichroic neodymium oxide doped glass substrate 50A having a forwardly facing, and an opposite rearwardly facing surfaces 54 and 55, respectively. Still further, a neutrally chromatic reflective layer 56 is positioned on the rearwardly facing surface thereof, and wherein the semitransparent mirror 50 defines a first or primary region 61, which reflects less than about 20% of a source of visible light having a first portion with wavelengths of about 565 to about 598 nanometers, and a bandwidth of less than about 35 nanometers, and greater than about 50%, of a second portion of the visible light having wavelengths which lie within a range of about 400 to about 700 nanometers, and further having a bandwidth of greater than about twice the bandwidth of the first portion of the source of light, and which strikes the forwardly facing surface thereof. The dichroic semitransparent mirror 50 further defines a secondary region 62, which is adjacent to the primary region 61, and which passes less than about 20% of the visible light having a wavelength of about 565 to about 598 nanometers, and greater than about 70% of the second portion of the visible light. Still further, the present invention 10 includes an emitter 30 of visible light positioned in light transmitting relation relative to the rearwardly facing surface of the dichroic neodymium oxide doped glass substrate 50A, and adjacent to the secondary region 62 thereof. The emitter 30, when energized, emits the second portion of the visible light 31 which is passed by the secondary region 62, and which forms a visibly discernible signal when viewed at a distance from the forwardly facing surface 54. As earlier discussed, and depending upon the concentration of neodymium oxide, the resulting semitransparent mirror may have a blue color when it is viewed under artificial light; or may have a red color when viewed under artificial light. In the present invention, the reflective layer 56 is removed to define, at least in part, the secondary region 62 of the semitransparent mirror 50. Still further, in some forms of the invention, a polarizing film 70 can be disposed in covering relation relative to the rearwardly facing surface 55 of the neodymium oxide doped glass substrate 50A. In this arrangement, the polarizing film 70 absorbs visible light having wavelengths of about 565 to about 598 nanometers, or other wavelengths depending upon the desired operational characteristics of the invention.

Therefore, it will be seen that the present invention achieves benefits not provided for in the prior art. In particular the present invention avoids many of the shortcomings and costs associate with the prior art practice of employing various types, lens assemblies, and the like. Still further, the present invention also provides design flexibility and further increases the safety of the overland vehicle by removing worrisome glare which often times impairs or restricts the vision of an operator during various daytime and nighttime driving conditions.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A signaling assembly, comprising:
a semitransparent mirror formed of a glass substrate having a mirror coating, and wherein the glass substrate substantially absorbs a predetermined band of yellow light, and which further defines a region through which visible light may pass; and
an emitter of visible light positioned adjacent to the semitransparent mirror and which, when energized, emits visible light which passes through the region of the semitransparent mirror which passes visible light to form a visibly discernible signal.

2. A signaling assembly as claimed in claim 1, and wherein the mirror coating comprises:
a primary region which reflects visible light, and a secondary region adjacent thereto, and which is ablated, in part, to completely remove the mirror coating, and which further passes visible light, while simultaneously reflecting visible light, and wherein the average reflectance of the primary and secondary regions is greater than about 50%, and wherein at viewing distances of greater that about 4 feet, under normal ambient lighting conditions, the primary and secondary regions are not normally discernible.

3. A signaling assembly as claimed in claim 2, and wherein the emitter of visible light is positioned adjacent to the secondary region, and which emits visible light which is passed by the secondary region to form a visibly discernible signal.

4. A signaling assembly as claimed in claim 3, and wherein the secondary region includes at least one substantially elliptically shaped light transmitting ablation which is formed in the mirror coating, and which allows the emitted visible light to pass therethrough.

5. A signaling assembly as claimed in claim 4, and wherein the elliptically shaped light transmitting ablation reflects, on average, greater than about 50% of visible light.

6. A signaling assembly as claimed in claim 4, and wherein the elliptically shaped light transmitting ablation has a major and a minor axis, and is further defined by a plurality of ablated lines which facilitate the transmission of the emitted visible light, provided by the emitter of visible light in a direction principally along the major axis thereof.

7. A signaling assembly as claimed in claim 6, and wherein the elliptically shaped light transmitting ablation has a first elliptically shaped zone, and a second zone which is adjacent thereto, and wherein the first elliptically shaped zone is formed of a plurality of curved substantially concentrically oriented ablated lines, and wherein the first elliptically shaped zone has a major axis which is substantially normal relative to the major axis of the elliptically shaped light transmitting ablation, and a minor axis which is substantially coaxially aligned relative thereto.

8. A signaling assembly as claimed in claim 7, and wherein the major axis of the elliptically shaped light transmitting ablation has a length dimension, and wherein the minor dimension of the first elliptically shaped zone has a length dimension which is less than about 50% of the length dimension of the major axis of the elliptically shaped light transmitting ablation.

9. A signaling assembly as claimed in claim 7, and wherein the second zone is defined by a plurality of spaced, arcuately shaped ablated lines, and wherein the major axis of the elliptically shaped light transmitting ablation substantially bisects each of the arcuately shaped ablated lines.

10. A signaling assembly as claimed in claim 7 and wherein the first elliptically shaped zone has a geometric center which is positioned along the major axis of the elliptically shaped light transmitting ablation, and wherein the second zone is defined by a plurality of spaced, arcuately shaped ablated lines which are oriented so as to be substantially bisected by the major axis of the elliptically shaped light transmitting ablation, and wherein the ablated lines forming, the first and second zones of the elliptically shaped light transmitting ablation each have a diminishing width dimension when measured along the major axis of the elliptically shaped light transmitting ablation in a direction extending from the geometric center through the second zone.

11. A signaling assembly as claimed in claim 10, and wherein the major axis of the elliptically shaped light transmitting ablation has a length dimension of less than about 10 millimeters, and the minor axis has a length dimension of less than about 8 millimeters.

12. A signaling assembly as claimed in claim 10, and wherein the secondary region of the mirror coating has a plurality of spaced light transmitting ablations which are positioned in a spaced predetermined geometric pattern, one relative to the others.

13. A signaling assembly as claimed in claim 10, and wherein the semitransparent mirror is mounted in a mirror housing which is affixed to an overland vehicle, and wherein the elliptically shaped light transmitting ablation principally passes light which is produced by the emitter of visible light in a direction which is horizontally laterally outwardly relative to the direction of movement of the overland vehicle.

14. A signaling assembly as claimed in claim 12, and wherein the distance of separation between the arcuately shaped ablated lines forming the second zone increase When measured along the major axis of the elliptically shaped light transmitting ablation, and in a direction extending from the first zone and through the second zone.

15. A signaling assembly as claimed in claim 14, and wherein the plurality of arcuately shaped ablated lines forming the second zone are substantially continuous, and wherein the concentrically oriented ablated lines are discontinuous.

16. A signaling assembly as claimed in claim 2, and wherein the visible light which is produced by the emitter of visible light includes the band of yellow light which is substantially absorbed by the semitransparent mirror.

17. A signaling assembly as claimed in claim 2, and wherein the visible light which is produced by the emitter of visible light does not include the band of yellow light which is substantially absorbed by the semitransparent mirror.

18. A signaling assembly as claimed in claim 2, and wherein the glass substrate has an effective concentration of neodymium oxide.

19. A signaling assembly as claimed in claim 18, and wherein the effective concentration of the neodymium oxide renders the semitransparent mirror substantially blue in appearance when viewed under artificial lighting conditions.

20. A signaling assembly as claimed in claim 2, and wherein the semitransparent mirror has a forward and a rearward facing surface, and wherein a polarizing filter is borne by the rearward facing surface of the semitransparent mirror, and which absorbs the predetermined band of yellow light to further reduce the amount of yellow light which is reflected by the semitransparent mirror.

21. A signaling assembly as claimed in claim 20, and wherein the rearward facing surface of the semitransparent mirror has a surface area, and wherein the polarizing film covers substantially the entire rearward facing surface area of the semitransparent mirror.

22. A signaling assembly as claimed in claim 20, and wherein the rearward facing surface of the semitransparent mirror has a surface area, and wherein the polarizing film covers only a portion of the rearward facing surface area of the semitransparent surface area.

23. A signaling assembly as claimed in claim 22, and wherein the polarizing film does not cover the secondary region of the semitransparent mirror through which the visible light passes.

24. A signaling assembly as claimed in claim 2, and wherein the signaling assembly is mounted on an overland vehicle and is used, at least in part, by an operator of the overland vehicle to view regions which are located laterally outwardly, and rearwardly of the overland vehicle, and wherein the predetermined band of yellow light, when reflected, forms at least in part, glare which diminishes the operator's view of the regions which are located laterally outwardly and rearwardly of the overland vehicle, and wherein the semitransparent mirror reduces the amount of glare experienced by the operator when a source of artificial light, having the predetermined band of yellow light, is reflected by the semitransparent mirror, and into the eyes of the operator.

25. A signaling assembly as claimed in claim 24, and wherein the semitransparent mirror comprises an electrochromic mirror.

26. A signaling assembly as claimed in claim 25, and wherein the semitransparent mirror has a forward and a rearward facing surface, and further comprises:
a circuit substrate which rests thereagainst the rearward facing surface of the semitransparent mirror, and wherein the emitter of visible light is mounted on the circuit substrate, and wherein the circuit substrate defines a region through which visible light may pass, and which is substantially aligned with the secondary region in the semitransparent mirror which passes visible light; and
a reflector oriented in covering, substantially eccentric reflecting relation relative to the emitter of visible light and which reflects the emitted visible light through both the region defined by the circuit substrate, and the secondary region of the semitransparent mirror which passes visible light to form the visibly discernible signal.

27. A signaling assembly as claimed in claim 2, and wherein the semitransparent mirror has a forward and a rearward facing surface, and further comprises:
a circuit substrate which is positioned in spaced relation relative to the rearward facing surface of the semitransparent mirror, and wherein the emitter of visible light is mounted on the circuit substrate.

28. A signaling assembly as claimed in claim 2, and wherein the predetermined band of yellow light has a bandwidth of less than about 35 nanometers, and a wavelength which lies predominately within the range of about 565 to about 598 nanometers, and wherein the emitter of visible light emits visible light which is passed by semitransparent mirror, and which has a bandwidth of at least equal to the bandwidth of the yellow light, and which has wavelengths which lie in the range of about 400 to about 770 nanometers.

29. A signaling assembly as claimed in claim 28, and wherein the semitransparent mirror simultaneously reflects and passes a band of visible light which has a bandwidth of greater than about 150 nanometers, while simultaneously substantially absorbing the yellow light which lies in the narrow band having the bandwidth of less than about 35 nanometers.

30. A signaling assembly as claimed in claim 29, and wherein the semitransparent mirror absorbs greater than about 80% of the yellow light.

31. A signaling assembly as claimed in claim 29, and wherein the semitransparent mirror has a forward and rearward facing surface, and wherein a polarizing filter is borne by the rearwardly facing surface, and which absorbs an amount of yellow light which is passed by the glass substrate, and wherein the glass substrate, alone, absorbs less than about 50% of the yellow light, and the polarizing film, alone, absorbs less than about 30% of the yellow light.

32. A signaling assembly as claimed in claim 31, and wherein the polarizing film does not cover the region of the semitransparent mirror which passes visible light.

33. A signaling assembly, comprising:
a semitransparent mirror formed of a dichroic neodymium oxide doped glass substrate having a forward facing, and an opposite rearward facing surface, and a neutrally chromatic reflective layer positioned on the rearward facing surface thereof, and wherein the semitransparent mirror defines a primary region which reflects less than about 20% of a source of visible light having a first portion with wavelengths of about 565 to about 598 nanometers, and a bandwidth of less than about 35 nanometers, and greater than about 50% of a second portion of the visible light having wavelengths which lie within a range of about 400 to about 700 nanometers, and further having a bandwidth of greater than about twice the bandwidth of the first portion of the source of visible light, and which strikes the forward facing surface thereof, and wherein the semitransparent mirror further defines a secondary region, which is adjacent to the primary region, and which passes less than about 20% of the visible light having a wavelength of about 565 to about 598 nanometers, and greater than about 70% of the second portion of the visible light; and
an emitter of visible light positioned in light transmitting relation relative to the rearward facing surface of the dichroic neodymium oxide doped glass substrate, and adjacent to the secondary region thereof, and wherein the emitter of visible light, when energized, emits the second portion of the visible light which is passed by the secondary region, and which forms a visibly discernible signal when viewed at a distance from the forward facing surface.

34. A signaling assembly as claimed in claim 33, and wherein the dichroic neodymium doped glass substrate has a neodymium oxide concentration which imparts a blue color to the glass substrate when it is viewed under artificial lighting conditions.

35. A signaling assembly as claimed in claim 33, and wherein the dichroic neodymium doped glass substrate has a neodymium oxide concentration which imparts a red color to the glass substrate when it is viewed under artificial lighting conditions.

36. A signaling assembly as claimed in claim 33, and further comprising:
a polarizing filter positioned therebetween the rearward facing surface of the neodymium oxide doped glass substrate, and the reflective coating, and wherein the polarizing filter absorbs visible light having wavelengths of about 565 to about 598 nanometers.

37. A signaling assembly as claimed in claim 33, and wherein the semitransparent mirror comprises an electrochromic mirror.

38. A signaling assembly as claimed in claim 33, and wherein the neutrally chromatic reflective layer is completely removed to define, at least in part, the secondary region of the semitransparent mirror.

39. A signaling assembly as claimed in claim 33, and further comprising:
a polarizing film disposed in covering relation relative to the rearward facing surface of the dichroic neodymium oxide doped glass substrate, and wherein the polarizing film absorbs visible light having wavelengths of about 565 to about 598 nanometers.

40. A signaling assembly as claimed in claim 39, and wherein the polarizing film covers substantially the entire surface area of the rearward facing surface of the dichroic neodymium oxide doped glass substrate.

41. A signaling assembly as claimed in claim 39, and wherein the polarizing film only covers the secondary region of the semitransparent mirror.

42. A signaling assembly as claimed in claim 39, and wherein the polarizing film only covers the primary region of the semitransparent mirror.

43. A signaling assembly as claimed in claim 39, and wherein the concentration of the neodymium oxide in the dichroic neodymium oxide doped glass substrate renders the glass blue in appearance when viewed under artificial lighting conditions.

44. A signaling assembly, comprising:
an enclosure defining an aperture;
a dichroic neodymium oxide doped semitransparent mirror borne by the enclosure and positioned in substantially occluding relation relative to the aperture, and wherein the dichroic neodymium oxide doped semitransparent mirror reflects and passes a broad band of visible light while simultaneously absorbing, at least in part, a predetermined narrow band of yellow light; and
an emitter of visible light borne by the enclosure and emitting visible light within the broad band of visible light which is passed by the dichroic neodymium doped semitransparent mirror.

45. A signaling assembly as claimed in claim 44, and wherein the broad band of visible light which is passed by the semitransparent mirror lies within a range of 400 to about 700 nanometers, and has a bandwidth at least equal to the bandwidth of the yellow light which is absorbed by the neodymium oxide doped semitransparent mirror.

46. A signaling assembly as claimed in claim 44, and wherein the broad band of visible light produced by the emitter of visible light includes the band of yellow light which is absorbed by the dichroic neodymium oxide doped semitransparent mirror.

47. A signaling assembly as claimed in claim 44, and wherein the broad band of visible light emitted by the emitter does not include the band of yellow light which is absorbed by the dichroic neodymium oxide doped semitransparent mirror.

48. A signaling assembly as claimed in claim 44, and wherein the broad band of visible light which is reflected and passed by the dichroic neodymium oxide doped semitransparent mirror is greater than about 150 nanometers.

49. A signaling assembly as claimed in claim 44, and further comprising:
a polarizing filter positioned therebetween the dichroic neodymium oxide doped semitransparent mirror and the emitter of visible light, and wherein the polarizing filter absorbs, at least in part, the band of yellow light which is absorbed by the dichroic neodymium oxide doped semitransparent mirror.

50. A signaling assembly as claimed in claim 49, and wherein the dichroic neodymium oxide doped semitransparent mirror absorbs a preponderance of the narrow band of yellow light.

51. A signaling assembly as claimed in claim 50, and wherein dichroic neodymium oxide doped semitransparent mirror appears blue when viewed under artificial light.

52. A signaling assembly, comprising:
a dichroic semitransparent mirror which absorbs a narrow band of visible light while simultaneously reflecting a broad band of visible light; and
an emitter of visible light positioned adjacent to the dichroic semitransparent mirror, and which emits light which is passed by the dichroic semitransparent mirror.

53. A signaling assembly as claimed in claim 52, and wherein the narrow band of visible light which is absorbed is less than about 50 nanometers in width.

54. A signaling assembly as claimed in claim 52, and wherein the broad band of visible light which is reflected by the dichroic semitransparent mirror is greater than 50 nanometers in width.

55. A signaling assembly as claimed in claim 52, and wherein the dichroic semitransparent mirror has a mirror coating which is substantially neutrally chromatic.

56. A signaling assembly as claimed in claim 55, and wherein the neutrally chromatic mirror coating is ablated to define a region through which the visible light provided by the emitter may pass therethrough.

57. A signaling assembly as claimed in claim 56, and wherein at viewing distances of greater than 4 feet, the ablated region of dichroic semitransparent mirror is not normally discernable.

58. A signaling assembly as claimed in claim 52, and wherein the dichroic semitransparent mirror is formed of a neodymium oxide doped glass substrate which substantially absorbs yellow light, and passes all remaining bands of visible light, and a substantially neutrally chromatic mirror coating borne by the neodymium oxide doped glass substrate, and which is effective for reflecting the bands of visible light which is not absorbed by the neodymium oxide doped glass substrate.
